(19) United States
(12) Patent Application Publication
(10) Pub. No.: US 2023/0185995 A1
(43) Pub. Date: Jun. 15, 2023

(54) ELECTROMAGNETIC FIELD SIMULATION METHOD BASED ON SUBGRIDDING TECHNIQUE AND ONE-STEP ALTERNATING-DIRECTION-IMPLICIT-FINITE-DIFFERENCE TIME-DOMAIN (ADI-FDTD) ALGORITHM

(71) Applicant: Anhui University, Hefei (CN)

(72) Inventors: Ming FANG, Hefei (CN); Chenran LIU, Hefei (CN); Jian FENG, Hefei (CN); Guoda XIE, Hefei (CN); Ke XU, Hefei (CN); Xueshi HOU, Hefei (CN); Mandi RONG, Hefei (CN); Zhixiang HUANG, Hefei (CN); Xianliang WU, Hefei (CN)

(21) Appl. No.: 18/166,927

(22) Filed: Feb. 9, 2023

(30) Foreign Application Priority Data
Apr. 27, 2022 (CN) 202210453158.9

(51) Int. Cl. G06F 30/23

(52) U.S. Cl. CPC G06F 30/23; G06F 2111/10

(57) ABSTRACT

An electromagnetic field simulation method based on subgridding technique and one-step alternating-direction-implicit-finite-difference time-domain (ADI-FDTD) algorithm is provided herein. The method includes establishing an electromagnetic field simulation model by setting an absorption boundary condition, a periodic boundary condition, a total field boundary condition and a scattering field boundary condition based on the one-step ADI-FDTD algorithm, subgridding technique and FDTD algorithm. The electromagnetic field simulation model is configured to select a detection point and a detection surface, obtain a time-domain waveform diagram of a reflection field of a simulation area, a time-domain waveform diagram of a transmission field of the simulation area and frequency-domain information of the simulation area, and simulate an electromagnetic field, by the electromagnetic field simulation model.

### CROSS-REFERENCE TO RELATED APPLICATIONS

This application claims the benefit of priority from Chinese Patent Application No. 202210453158.9, filed on Apr. 27, 2022. The content of the aforementioned application, including any intervening amendments thereto, is incorporated herein by reference in its entirety.

### TECHNICAL FIELD

This application relates to time-domain finite-difference method for electromagnetic wave, and more particularly to an electromagnetic field simulation method based on subgridding technique and one-step alternating-direction-implicit-finite-difference time-domain (ADI-FDTD) algorithm.

### BACKGROUND

Traditional finite-difference time-domain (FDTD) algorithm is widely used, because it is easy for programming, and suitable for the processing of inhomogeneous media and dispersive media. However, the simulation of models with tiny complex structures or high dielectric constant requires dense grid for division, which consumes huge computing resources. In addition, limited by the Courant-Friedrich-Levy (CFL) stability condition, the time step in the FDTD algorithm becomes very small, leading to a relatively long simulation time.

To overcome the problem of the huge computing resources caused by dense grid division, the subgridding technique is applied in the FDTD algorithm. The subgridding technique can perform division in areas with tiny complex structures or high dielectric constant with dense grid, and performs division with coarse grid in other areas, which saves a large number of computing resources. However, due to the constraints of CFL conditions of dense grid, the time step is still very small. In order to solve the problem caused by small time step, researchers have proposed the one-step alternating-direction-implicit (ADI) method, which alleviates or eliminates the limitation of the CFL stability condition, and can be applied in subgridding technique to expand the time step of the dense grid, so that the time step of the entire simulation area is only limited by the CFL condition of dense grid. To combine the advantages of the two technologies, the subgridding technique and the one-step ADI-FDTD algorithm are applied to the traditional FDTD algorithm, which can effectively reduce the computing resources and shorten computing time. Therefore, the combination of FDTD and subgridding technique and one-step ADI-FDTD algorithm has emerged as a critical issue to be addressed by the researchers.

### SUMMARY

An objective of this application is to provide an electromagnetic field simulation method based on subgridding technique and one-step alternating-direction-implicit-finite-difference time-domain (ADI-FDTD) algorithm, which improves the simulation efficiency of the traditional FDTD algorithm for fine tiny structure and medium of higher refractive index, and reduces computing resources.

Technical solutions of this application are described as follows.

This application provides an electromagnetic field simulation method based on subgridding technique and one-step alternating-direction-implicit-finite-difference time-domain (ADI-FDTD) algorithm, comprising:

establishing an electromagnetic field simulation model by setting an absorption boundary condition, a periodic boundary condition, a total field boundary condition and a scattering field boundary condition based on the one-step ADI-FDTD algorithm, the subgridding technique and FDTD algorithm; wherein the electromagnetic field simulation model is configured to select a detection point and a detection surface, obtain a time-domain waveform diagram of a reflection field of a simulation area, a time-domain waveform diagram of a transmission field of the simulation area and frequency-domain information of the simulation area, and simulate an electromagnetic field.

In an embodiment, the step of “establishing an electromagnetic field simulation model” comprises:

based on the one-step ADI-FDTD algorithm, acquiring a first coefficient matrix corresponding to a boundary form of a perfect electric conductor and a second coefficient matrix corresponding to the periodic boundary condition; and

based on a tiny structure and a high dielectric constant of the simulation area, respectively generating the absorption boundary condition and the periodic boundary condition according to the first coefficient matrix and the second coefficient matrix.

In an embodiment, the step of “establishing an electromagnetic field simulation model” comprises: obtaining a plane wave source by setting the total field boundary condition and the scattering field boundary condition; and selecting the detection point and the detection surface according to the plane wave source.

In an embodiment, in the step of “establishing an electromagnetic field simulation model”, the electromagnetic field is simulated by:

based on the simulation area, setting a subgrid;

initializing an electric field component and a magnetic field component of a coarse grid, and initializing an electric field component and a magnetic field component of a dense grid;

calculating the electric field component of the coarse grid by FDTD algorithm;

after calculating an electric field component on an interface, transferring the electric field component on the interface to the dense grid by means of linear interpolation method; and using the one-step ADI-FDTD algorithm to calculate the electric field component of the dense grid and the magnetic field component of the dense grid; and

weighting the magnetic field component of the dense grid to obtain a magnetic field component on the interface; and using the FDTD algorithm to calculate the magnetic field component of the coarse grid.

In an embodiment, the step of “establishing an electromagnetic field simulation model” comprises: based on Maxwell equation, generating a two-step alternating-direction-implicit-finite-difference time-domain (ADI-FDTD) scheme based on an alternating-direction-implicit scheme; and

based on the two-step ADI-FDTD scheme, generating the one-step ADI-FDTD algorithm by algebraic operation.

In an embodiment, in the step of “generating a two-step alternating-direction-implicit-finite-difference time-domain (ADI-FDTD) scheme”, the two-step ADI-FDTD scheme comprises a first time step and a second time step;

the first time step is expressed as:

$$\begin{matrix}{E}^{n + 1 / 2} = {E}^{n} + \frac{Δ t}{2 ε} ( A {H}^{n + 1 / 2} - B {H}^{n} ) \\ {H}^{n + 1 / 2} = {H}^{n} + \frac{Δ t}{2 μ} ( {BE}^{n + 1 / 2} - {AE}^{n} )\end{matrix} ; and$$

the second time step is expressed as:

$$\begin{matrix}{E}^{n + 1} = {E}^{n + 1 / 2} + \frac{Δ t}{2 ε} ( A {H}^{n + 1 / 2} - B {H}^{n + 1} ) \\ {H}^{n + 1} = {H}^{n + 1 / 2} + \frac{Δ t}{2 μ} ( {BE}^{n + 1 / 2} - {AE}^{n + 1} )\end{matrix} ;$$

wherein E represents an electric field; H represents a magnetic field; ε is a dielectric constant; μ is a magnetic conductivity; a matrix A is expressed as:

$$A = [ \begin{matrix}0 & 0 & \partial / \partial y \\ \partial / \partial z & 0 & 0 \\ 0 & \partial / \partial x & 0\end{matrix} ] ;$$

and a matrix B is expressed as:

$$B = [ \begin{matrix}0 & \partial / \partial z & 0 \\ 0 & 0 & \partial / \partial x \\ \partial / \partial y & 0 & 0\end{matrix} ] .$$

In an embodiment, in the step of “generating the one-step ADI-FDTD algorithm”, the one-step ADI-FDTD algorithm is expressed as:

$$\begin{matrix}( I - \frac{Δ {t}^{2}}{4 με} AB ) {E}^{n + 1 / 2} = ( I - \frac{Δ {t}^{2}}{4 με} A B ) {E}^{n - 1 / 2} + \frac{Δ t}{ε} ( {AH}^{n} - {BH}^{n} ) \\ ( I - \frac{Δ {t}^{2}}{4 μ ε} AB ) {H}^{n + 1} = ( I - \frac{Δ {t}^{2}}{4 με} A B ) {H}^{n} + \frac{Δ t}{μ} ( B {E}^{n + 1 / 2} - A {E}^{n + 1 / 2} )\end{matrix} .$$

In an embodiment, in the step of “respectively generating the absorption boundary condition and the periodic boundary condition according to the first coefficient matrix and the second coefficient matrix”, the first coefficient matrix is expressed as:

$$Λ = [ \begin{matrix}\begin{matrix}1 & 0 & 0 & 0 & 0 & 0 & 0 \\ b & a & b & 0 & 0 & 0 & 0 \\ 0 & ⊏ & ⊏ & ▯ & & & 0 \\ 0 & 0 & ▯ & ▯ & ⊏ & & \end{matrix} ⌉ \\ \begin{matrix}0 & 0 & 0 & ▯ & ▯ & ⊏ & \end{matrix} \\ \begin{matrix}0 & 0 & 0 & 0 & b & a & b \\ 0 & 0 & 0 & 0 & 0 & 0 & 1\end{matrix} ⌋\end{matrix} ;$$

and

the second coefficient matrix is expressed as:

$$Λ = [ \begin{matrix}\begin{matrix}a & b & 0 & 0 & 0 & 0 & b \\ b & a & b & 0 & 0 & 0 & 0 \\ 0 & ⊏ & ⊏ & ▯ & & & 0 \\ 0 & 0 & ▯ & ⊏ & ▯ & & \end{matrix} ⌉ \\ \begin{matrix}0 & 0 & 0 & ▯ & ▯ & ▯ & \end{matrix} \\ \begin{matrix}0 & 0 & 0 & 0 & b & a & b \\ b & 0 & 0 & 0 & 0 & b & a\end{matrix} ⌋\end{matrix} ;$$

wherein

$$a = 1 + \frac{Δ {t}^{2}}{2 εμΔ {y}^{2}} ; and b = - \frac{Δ {t}^{2}}{4 εμΔ {y}^{2}} .$$

In an embodiment, the frequency-domain information of the simulation area is obtained by acquiring a time-domain result of the detection surface to generate the frequency-domain information through Fourier transform.

In an embodiment, when the electromagnetic field is simulated, the electromagnetic field simulation method is stored in a storage medium in a form of a computer program, and applied to a device with a simulation function to simulate the electromagnetic field.

Compared with the prior art, this application has the following beneficial effects.

The electromagnetic field simulation method provided herein can save 39.28% of memory and reduce 98.01% of computing time.

### BRIEF DESCRIPTION OF THE DRAWINGS

In order to make the technical solutions in the embodiments of this disclosure clearer, this disclosure will be described in detail below with reference to the accompanying drawings. Obviously, it should be noted that the embodiments described blow are merely some embodiments of this disclosure. It should be understood for those of ordinary skill in the art that other accompanying drawings can also be obtained by the following accompanying drawings without paying any creative efforts.

FIG. 1 is a flowchart of a finite-difference time-domain (FDTD) algorithm based on subgridding technique and alternating-direction-implicit-finite-difference time-domain (ADI-FDTD) technology according to an embodiment of this application;

FIG. 2 is a schematic diagram (two-dimensional diagram) showing an interpolation of an interface between a coarse grid and a dense grid according to an embodiment of this application;

FIG. 3 is a schematic diagram (three-dimensional schematic diagram) showing the interface between the coarse grid and the dense grid and weighting H_{z} according to an embodiment of this application;

FIG. 4 is a schematic diagram of a simulation area and a structure of a frequency selective surface according to an embodiment of this application;

FIG. 5 is a time-domain waveform diagram of an E_{z} component of a reflection field region according to an embodiment of this application;

FIG. 6 is a time-domain waveform diagram of the E_{z} component of a transmission field region according to an embodiment of this application; and

FIG. 7 shows a transmission coefficient and a reflection coefficient of the frequency selective surface according to an embodiment of this application.

### DETAILED DESCRIPTION OF EMBODIMENTS

In order to make the objectives, technical solutions and beneficial effects in the embodiments of this disclosure more clear and complete, this disclosure will be described in detail below with reference to the accompanying drawings. Obviously, the embodiments described blow are merely some embodiments of this disclosure. The components of the embodiments in this disclosure generally described and illustrated in the accompanying drawings herein can be arranged and designed in various configurations. Therefore, the embodiments provided in the accompanying drawings are merely some selective embodiments of this disclosure, and not intended to limit this disclosure. Based on the embodiments of this disclosure, it should be understood that any other embodiments obtained by those skilled in the art without departing from the spirit of this disclosure should fall within the scope of this application defined by the appended claims.

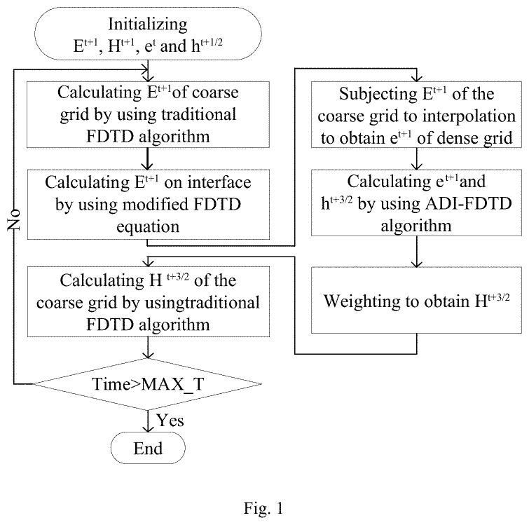

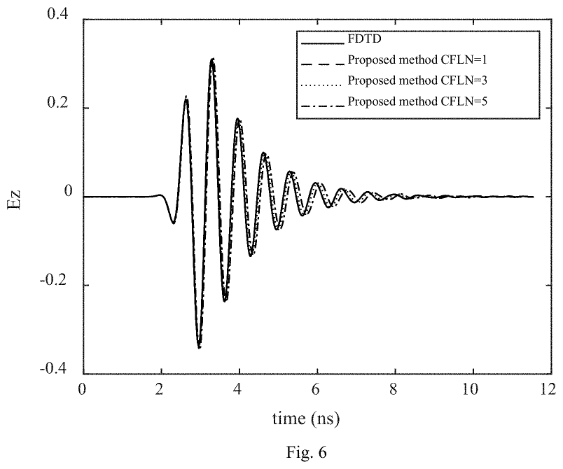

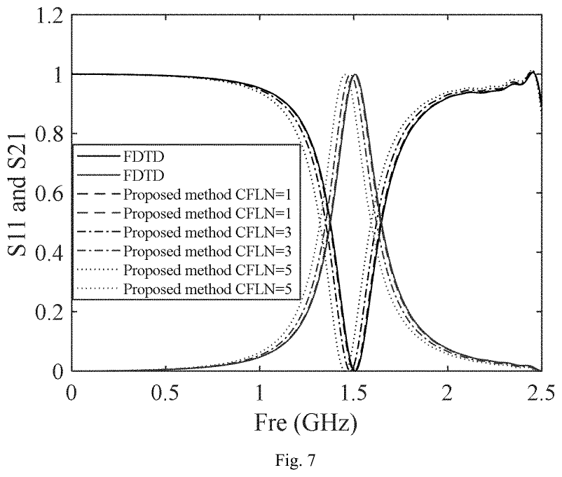

Referring to FIGS. 1-7, provided herein is an electromagnetic field simulation method based on subgridding technique and one-step alternating-direction-implicit-finite-difference time-domain (ADI-FDTD) algorithm, which is performed through the following steps.

An electromagnetic field simulation model is established by setting an absorption boundary condition, a periodic boundary condition, a total field boundary condition and a scattering field boundary condition based on the one-step ADI-FDTD algorithm, subgridding technique and FDTD algorithm. The electromagnetic field simulation model is configured to select a detection point and a detection surface, obtain a time-domain waveform diagram of a reflection field of a simulation area, a time-domain waveform diagram of a transmission field of the simulation area and frequency-domain information of the simulation area, and simulate an electromagnetic field.

In this embodiment, when the electromagnetic field simulation model is established, a first coefficient matrix corresponding to a boundary form of a perfect electric conductor and a second coefficient matrix corresponding to the periodic boundary condition are acquired based on the one-step ADI-FDTD algorithm.

Based on a tiny structure and a high dielectric constant of the simulation area, the absorption boundary condition and the periodic boundary condition are respectively generated according to the first coefficient matrix and the second coefficient matrix.

In this embodiment, when the electromagnetic field simulation model is established, a plane wave source is obtained by setting the total field boundary condition and the scattering field boundary condition.

The detection point and the detection surface are selected according to the plane wave source.

In this embodiment, when the electromagnetic field simulation model is established, the electromagnetic field is simulated through the following steps.

A subgrid is set based on the simulation area.

An electric field component and a magnetic field component of a coarse grid are initialized, and an electric field component and a magnetic field component of a dense grid are initialized.

The electric field component of the coarse grid is calculated by FDTD algorithm.

After calculating an electric field component on an interface by the one-step ADI-FDTD algorithm, the electric field component on the interface is transferred to the dense grid by means of linear interpolation method. The one-step ADI-FDTD algorithm is used to calculate the electric field component of the dense grid and the magnetic field component of the dense grid.

The magnetic field component of the dense grid is weighted to obtain a magnetic field component on the interface. The FDTD algorithm is used to calculate the magnetic field component of the coarse grid.

In this embodiment, when the electromagnetic field simulation model is established, based on Maxwell equation, a two-step alternating-direction-implicit-finite-difference time-domain (ADI-FDTD) scheme is generated based on an alternating-direction-implicit scheme.

Based on the two-step ADI-FDTD scheme, the one-step ADI-FDTD algorithm is generated by algebraic operation.

In an embodiment, during the process of generating a two-step alternating-direction-implicit-finite-difference time-domain (ADI-FDTD) scheme, the two-step ADI-FDTD scheme includes a first time step and a second time step.

The first time step is expressed as:

$$\begin{matrix}{E}^{n + 1 / 2} = {E}^{n} + \frac{Δ t}{2 ε} ( A {H}^{n + 1 / 2} - B {H}^{n} ) \\ {H}^{n + 1 / 2} = {H}^{n} + \frac{Δ t}{2 μ} ( B {E}^{n + 1 / 2} - {AE}^{n} )\end{matrix} ;$$

the second time step is expressed as:

$$\begin{matrix}{E}^{n + 1} = {E}^{n + 1 / 2} + \frac{Δ t}{2 ε} ( A {H}^{n + 1 / 2} - B {H}^{n + 1} ) \\ {H}^{n + 1} = {H}^{n + 1 / 2} + \frac{Δ t}{2 μ} ( B {E}^{n + 1 / 2} - {AE}^{n + 1} )\end{matrix} ;$$

where E represents an electric field; H represents a magnetic field; ε is a dielectric constant; μ is a magnetic conductivity; a matrix A is expressed as:

$$A = [ \begin{matrix}0 & 0 & \partial / \partial y \\ \partial / \partial z & 0 & 0 \\ 0 & \partial / \partial x & 0\end{matrix} ] ;$$

and a matrix B is expressed as:

$$B = [ \begin{matrix}0 & \partial / \partial z & 0 \\ 0 & 0 & \partial / \partial x \\ \partial / \partial y & 0 & 0\end{matrix} ] .$$

In this embodiment, during the process of generating one-step ADI-FDTD algorithm, the one-step ADI-FDTD algorithm is expressed as:

$$\begin{matrix}( I - \frac{Δ {t}^{2}}{4 με} AB ) {E}^{n + 1 / 2} = ( I - \frac{Δ {t}^{2}}{4 με} A B ) {E}^{n - 1 / 2} + \frac{Δ t}{ε} ( {AH}^{n} - {BH}^{n} ) \\ ( I - \frac{Δ {t}^{2}}{4 μ ε} AB ) {H}^{n + 1} = ( I - \frac{Δ {t}^{2}}{4 με} A B ) {H}^{n} + \frac{Δ t}{μ} ( B {E}^{n + 1 / 2} - A {E}^{n + 1 / 2} )\end{matrix} .$$

In this embodiment, during the process of generating the absorption boundary condition and the periodic boundary condition, the first coefficient matrix is expressed as:

$$Λ = [ \begin{matrix}\begin{matrix}1 & 0 & 0 & 0 & 0 & 0 & 0 \\ b & a & b & 0 & 0 & 0 & 0 \\ 0 & ⊏ & ⊏ & ▯ & & & 0 \\ 0 & 0 & ▯ & ▯ & ⊏ & & \end{matrix} ⌉ \\ \begin{matrix}0 & 0 & 0 & ▯ & ▯ & ⊏ & \end{matrix} \\ \begin{matrix}0 & 0 & 0 & 0 & b & a & b \\ 0 & 0 & 0 & 0 & 0 & 0 & 1\end{matrix} ⌋\end{matrix} ;$$

and

the second coefficient matrix is expressed as:

$$Λ = [ \begin{matrix}\begin{matrix}a & b & 0 & 0 & 0 & 0 & b \\ b & a & b & 0 & 0 & 0 & 0 \\ 0 & ⊏ & ⊏ & ▯ & & & 0 \\ 0 & 0 & ▯ & ⊏ & ▯ & & \end{matrix} ⌉ \\ \begin{matrix}00 & 0 & ▯ & ▯ & ▯ & & \end{matrix} \\ \begin{matrix}0 & 0 & 0 & 0 & b & a & b \\ b & 0 & 0 & 0 & 0 & b & a\end{matrix} ⌋\end{matrix} ;$$

where

$$a = 1 + \frac{Δ {t}^{2}}{2 εμΔ {y}^{2}} ; and b = - \frac{Δ {t}^{2}}{4 εμΔ {y}^{2}} .$$

In this embodiment, when the frequency-domain information of the simulation area is obtained, a time-domain result of the detection surface is acquired to generate the frequency-domain information through Fourier transform.

In this embodiment, when an electromagnetic field is simulated, the electromagnetic field simulation method is stored in a storage medium in a form of a computer program, and applied to a device with a simulation function to simulate the electromagnetic field.

### Embodiment 1

Provided herein is an electromagnetic field simulation method based on subgridding technique and one-step alternating-direction-implicit-finite-difference time-domain (ADI-FDTD) algorithm. The electromagnetic field simulation method is intended to reduce the computing resource and shorten the simulation time of the of the traditional finite-difference time-domain (FDTD) algorithm. Starting from the alternating-direction-implicit scheme, an iterative equation of the one-step ADI-FDTD algorithm is provided. Through combination with the subgridding technique, the coefficient matrix corresponding to a boundary of a perfect electric conductor (PEC) and the coefficient matrix corresponding to the periodic boundary condition (PBC) are provided, and the interpolation way of the coarse grid and the dense grid is provided. According to the characteristics of the subgrid, the iterative equation of the electric field on the interface between the coarse grid and the dense grid is provided. A calculating example of the frequency selective surface example is provided to verify the accuracy and efficiency of the method proposed herein. The time-domain waveforms of the electric field in the total field and the scattering field and a S parameter of the frequency selective surface are recorded to verify the accuracy of the proposed algorithm. By comparing the traditional FDTD algorithm and the proposed algorithm in terms of memory usage and computing time consumption, it is proved that the proposed algorithm is high-efficient.

Referring to an embodiment shown in FIG. 1, illustrated herein is a flowchart of a finite-difference time-domain (FDTD) algorithm based on subgridding technique and alternating-direction-implicit-finite-difference time-domain (ADI-FDTD) technology, which is performed through the following steps.

(S01) E^{t} and H^{t+1/2} of the coarse grid and e^{t} and h^{t+1/2} of the dense grid are initialized.

(S02) E^{t+1} of the coarse grid is calculated by using traditional FDTD algorithm.

(S03) E^{t+1} of an interface between the coarse grid and the dense grid is calculated by using the one-step ADI-FDTD algorithm;

(S04) The electric field in the coarse grid on the interface is transferred to the dense grid by means of linear interpolation method.

(S05) e^{t+1}, h^{t+3/2} of the dense grid are calculated by using the one-step ADI-FDTD algorithm.

(S06) The h^{t+3/2} is weighted to obtain H^{t+3/2} of the interface.

(S07) H^{t+3/2} of the coarse grid is calculated by using the traditional FDTD algorithm.

(S08) Whether loop iteration is end is determined.

In the above steps, E represents an electric field in the coarse grid; H represents a magnetic field in the coarse grid; e represents an electric field in the dense grid; h represents a magnetic field in the dense grid; and superscripts of E, H, e and h denote time steps.

In this embodiment, Maxwell equation is used and shown as follows:

$$\frac{\partial E}{\partial t} = \frac{1}{ε} ( A - B ) H ; \qquad ( 1 a )$$

$$\frac{\partial H}{\partial t} = \frac{1}{μ} ( B - A ) E ; \qquad ( 1 b )$$

where ε is a dielectric constant and μ is a magnetic conductivity; and a matrix A is expressed as

$$A = [ \begin{matrix}0 & 0 & \partial / \partial y \\ \partial / \partial z & 0 & 0 \\ 0 & \partial / \partial x & 0\end{matrix} ] ,$$

and a matrix B is expressed as

$$B = [ \begin{matrix}0 & \partial / \partial z & 0 \\ 0 & 0 & \partial / \partial x \\ \partial / \partial y & 0 & 0\end{matrix} ] ,$$

where x, y, and z indicate three directions of space.

Based on the alternating-direction-implicit scheme, the above Maxwell equation (1) is written in a two-step ADI-FDTD scheme, where a first sub-time step is expressed as:

$${E}^{n + 1 / 2} = {E}^{n} + \frac{Δ t}{2 ε} ( A {H}^{n + 1 / 2} - B {H}^{n} ) ; \qquad ( 2 a )$$

$${H}^{n + 1 / 2} = {H}^{n} + \frac{Δ t}{2 μ} ( B {E}^{n + 1 / 2} - A {E}^{n} ) ; \qquad ( 2 b )$$

and a second sub-time step is expressed as:

$${E}^{n + 1} = {E}^{n + 1 / 2} + \frac{Δ t}{2 ε} ( A {H}^{n + 1 / 2} - B {H}^{n + 1} ) ; \qquad ( 3 a )$$

$${H}^{n + 1} = {H}^{n + 1 / 2} + \frac{Δ t}{2 μ} ( B {E}^{n + 1 / 2} - A {E}^{n + 1} ) . \qquad ( 3 b )$$

The two-step ADI-FDTD scheme is converted into the one-step ADI-FDTD algorithm by algebraic operation as follows:

$$( I - \frac{Δ {t}^{2}}{4 μ ε} AB ) {E}^{n + 1 / 2} = ( I - \frac{Δ {t}^{2}}{4 μ ε} A B ) {E}^{n - 1 / 2} + \frac{Δ t}{ε} ( A {H}^{n} - B {H}^{n} ) ; \qquad ( 4 a )$$

$$( I - \frac{Δ {t}^{2}}{4 μ ε} AB ) {H}^{n + 1} = ( I - \frac{Δ {t}^{2}}{4 μ ε} A B ) {H}^{n} + \frac{Δ t}{μ} ( B {E}^{n + 1 / 2} - A {E}^{n + 1 / 2} ) . \qquad ( 4 b )$$

Based on the one-step ADI-FDTD algorithm, discrete equations of the electric field Eₓ and the magnetic field Hₓ are respectively shown as follows:

$$\begin{matrix}( 1 + \frac{Δ {t}^{2}}{2 μ εΔ {y}^{2}} ) {E}_{\text{?}}^{\text{?} + 1 / 2} ( i + 1 / 2 , j , k ) - \frac{Δ {t}^{2}}{4 μ εΔ {y}^{2}} ( {E}_{\text{?}}^{\text{?} + 1 / 2} ( i + 1 / 2 , j + 1 , k ) + {E}_{\text{?}}^{\text{?} + 1 / 2} ( i + 1 / 2 , j - 1 , k ) ) \\ = ( 1 + \frac{Δ {t}^{2}}{2 μεΔ {y}^{2}} ) {E}_{\text{?}}^{\text{?} - 1 / 2} ( i + 1 / 2 , j , k ) - \frac{Δ {t}^{2}}{4 μεΔ {y}^{2}} ( {E}_{\text{?}}^{\text{?} - 1 / 2} ( i + 1 / 2 , j + 1 , k ) + {E}_{\text{?}}^{\text{?} - 1 / 2} ( i + 1 / 2 , j - 1 , k ) ) \\ + \frac{Δ t}{ε} ( \frac{{H}_{\text{?}}^{\text{?}} ( i + 1 / 2 , j + 1 / 2 , k ) - {H}_{\text{?}}^{\text{?}} ( i + 1 / 2 , j - 1 / 2 , k )}{Δ y} - \frac{{H}_{y}^{\text{?}} ( i + 1 / 2 , j , k + 1 / 2 ) - {H}_{y}^{\text{?}} ( i + 1 / 2 , j , k - 1 / 2 )}{Δ z} )\end{matrix} \qquad ( 5 a )$$

$$\begin{matrix}( 1 + \frac{Δ {t}^{2}}{2 μ εΔ {y}^{2}} ) {H}_{\text{?}}^{\text{?} + 1} ( i , j + 1 / 2 , k + 1 / 2 ) - \frac{{t}^{2}}{4 μ εΔ {y}^{2}} ( {H}_{\text{?}}^{\text{?} + 1} ( 1 , j + 3 / 2 , k + 1 / 2 ) + {H}_{\text{?}}^{\text{?} + 1} ( i , j - 1 / 2 , k + 1 / 2 ) ) \\ = ( 1 + \frac{Δ {t}^{2}}{2 μεΔ {y}^{2}} ) {H}_{x}^{n} ( i , j + 1 / 2 , k + 1 / 2 ) - \frac{Δ {t}^{2}}{4 μ εΔ {y}^{2}} ( {H}_{x}^{\text{?}} ( i , j + 3 / 2 , k + 1 / 2 ) + {H}_{x}^{N} ( i , j - 1 / 2 , k + 1 / 2 ) ) \\ + \frac{Δ t}{μ} ( \frac{{E}_{y}^{n + 1 / 2} ( i , j + 1 / 2 , k + 1 ) - {E}_{y}^{n - 1 / 2} ( i , j + 1 , k )}{Δ z} - \frac{{E}_{z}^{n - 1 / 2} ( i , j + 1 , k + 1 / 2 ) - {E}_{z}^{n + 1 / 2} ( i , j , k + 1 / 2 )}{Δ y} )\end{matrix} \qquad ( 5 b )$$

$$\text{?} \text{indicates text missing or illegible when filed}$$

where a y-direction component of the electric field and a z-direction component of the electric field, and a y-direction component of the magnetic field and a z-direction component of the magnetic field are obtained in the same way.

A coefficient matrix on the left in equation (5) is a tridiagonal matrix, which is shown as follows:

$$Λ = [ \begin{matrix}\begin{matrix}a & b & 0 & 0 & 0 & 0 & 0 \\ b & a & b & 0 & 0 & 0 & 0 \\ 0 & ▯ & ⊏ & ▯ & & & 0 \\ 0 & 0 & ▯ & ⊏ & ⊏ & & \end{matrix} ⌉ \\ \begin{matrix}00 & 0 & ▯ & ▯ & ▯ & & \end{matrix} \\ \begin{matrix}0 & 0 & 0 & 0 & b & a & b \\ 0 & 0 & 0 & 0 & 0 & b & a\end{matrix} ⌋\end{matrix} \qquad ( 6 )$$

where

$$a = 1 + \frac{Δ {t}^{2}}{2 εμΔ {y}^{2}} and b = - \frac{Δ {t}^{2}}{4 εμΔ {y}^{2}} .$$

In this embodiment, since the ADI-FDTD algorithm requires to be combined with the subgridding technique, and the periodic arrangement of the frequency selective surface needs to be taken into consideration, A matrix of the boundary form of the perfect electric conductor (PEC) and A matrix of the periodic boundary condition form are respectively expressed as follows:

$$Λ = [ \begin{matrix}\begin{matrix}1 & 0 & 0 & 0 & 0 & 0 & 0 \\ b & a & b & 0 & 0 & 0 & 0 \\ 0 & ▯ & ▯ & ▯ & & & 0 \\ 0 & 0 & ⊏ & ⊏ & ⊏ & & \end{matrix} ⌉ \\ \begin{matrix}00 & 0 & ▯ & ⊏ & ⊏ & & \end{matrix} \\ \begin{matrix}0 & 0 & 0 & 0 & b & a & b \\ 0 & 0 & 0 & 0 & 0 & 0 & 1\end{matrix} ⌋\end{matrix} , and$$

$$Λ = [ \begin{matrix}\begin{matrix}a & b & 0 & 0 & 0 & 0 & b \\ b & a & b & 0 & 0 & 0 & 0 \\ 0 & ⊏ & ▯ & ⊏ & & & 0 \\ 0 & 0 & ▯ & ⊏ & ▯ & & \end{matrix} ⌉ \\ \begin{matrix}00 & 0 & ⊏ & ⊏ & ▯ & & \end{matrix} \\ \begin{matrix}0 & 0 & 0 & 0 & b & a & b \\ b & 0 & 0 & 0 & 0 & b & a\end{matrix} ⌋\end{matrix} .$$

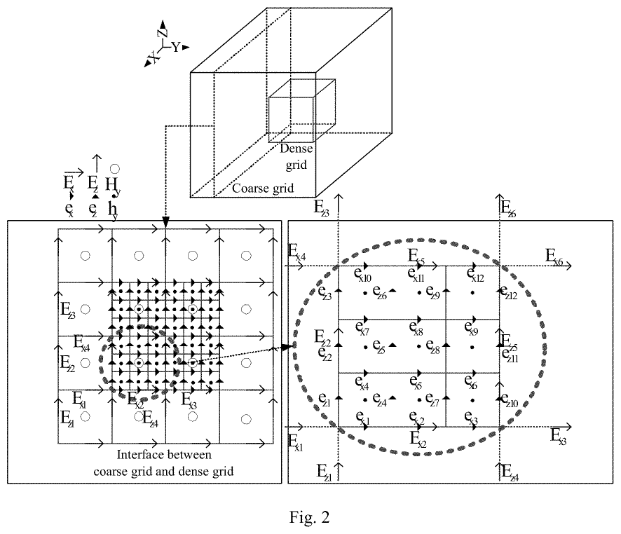

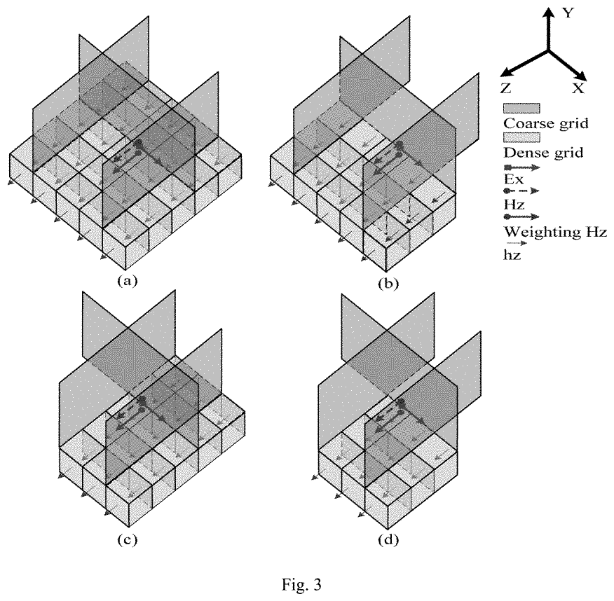

Referring to FIGS. 2 and 3, the subgrid used herein is illustrated in detail.

The traditional FDTD algorithm generally adopts a uniform Yee grid to divide the target. When the size of target is excessively small, the dense grid is required to divide the target, which causes the large memory usage and long simulation time of the entire simulation program. The subgrid used herein has two advantages, where the iterations of the electric filed and the magnetic field in the whole coarse grid region is not required, and the reverse interpolation of the values of the dense grid into the coarse grid is not needed. FIG. 2 illustrates the interpolation method used herein, which is specifically performed as follows.

When the electric field of the coarse field coincides with the electric field of the dense grid, the interpolation is performed as follows:

eₓ₂=Eₓ₂, and eₓ₁₁=Eₓ₅ (7).

When the electric field of the coarse field does not coincide with the electric field of the dense grid, the interpolation is performed as follows:

eₓ₁=2/3Eₓ₂+1/3Eₓ₁,eₓ₃=2/3Eₓ₂+1/3Eₓ₃ (8);

eₓ₁₀=2/3Eₓ₅+1/3Eₓ₄eₓ₁₂=2/3Eₓ₅+1/3Eₓ₆ (9);

eₓ₄=2/3eₓ₁+1/3eₓ₁₀, eₓ₇=2/3eₓ₃+1/3eₓ₁ (10).

The electric field of the interface is allowed to be calculated through the traditional FDTD equations, but the space step needs to be corrected. Taking Eₓ as an example,

$${E}_{x}^{q + 1} ( m , n , p ) = {E}_{x}^{q} ( m , n , p ) + ( \frac{Δ t}{ε ( \frac{ϛ + 1}{2 ϛ} Δ y )} ( {\sum }_{k = 1}^{( 2 ϛ - 1 )} {C}_{k} \times {h}_{z k}^{q + \frac{1}{2}} - {H}_{z}^{q + \frac{1}{2}} ( m , n - 1 , p ) ) - \frac{Δ t}{εΔ z} ( {H}_{y}^{q + \frac{1}{2}} ( m , n , p ) - {H}_{y}^{q + \frac{1}{2}} ( m , n , p - 1 ) ) ) \qquad ( 11 )$$

where ζ is a coarse grid-to-dense grid ratio, Cₖ represents a coefficient corresponding to the magnetic field in each dense grid in the weighting matrix. Corresponding to the four cases shown in FIG. 3, the coefficient matrix C has the following four forms:

$$C = [ \begin{matrix}1 & 2 & … & & … & & \\ 2 & {2}^{2} & & 2 ϛ & & {2}^{2} & 2 \\ ⋮ & & ⋱ & ⋮ & ⋰ & & ⋮ \\ ϛ & 2 ϛ & … & & … & & \\ ⋮ & & ⋰ & ⋮ & ⋱ & & ⋮ \\ 2 & {2}^{2} & & 2 ϛ & & {2}^{2} & 2 \\ 1 & 2 & … & & … & & \end{matrix} ] / {ϛ}^{4} \qquad ( 12 )$$

$$C = [ \begin{matrix}1 & 2 & … & & … & & 1 \\ 2 & {2}^{2} & & 2 ϛ & & {2}^{2} & 2 \\ ⋮ & & ⋱ & ⋮ & ⋰ & & ⋮ \\ ϛ - 1 & 2 ( ϛ - 1 ) & … & & … & & ϛ - 1\end{matrix} ] / ( {\text{?}}^{3} \times \frac{ϛ - 1}{\text{?}} ) \qquad ( 13 )$$

$$C = [ \begin{matrix}{\underbrace{\begin{matrix} & & & & & & \\ ϛ & … & & & … & & \\ 2 ϛ & … & & 2 ϛ & & {2}^{2} & 2 \\ ⋮ & & & ⋮ & ⋰ & & ⋮ \\ {ϛ}^{2} & … & & & … & & \\ ⋮ & & & ⋮ & ⋱ & & ⋮ \\ 2 ϛ & … & & 2 ϛ & & {2}^{2} & 2 \\ \text{?} & … & & & … & & \end{matrix}}}_{( 3 ϛ - 1 ) / 2} \\ \end{matrix} ] {\text{?}}^{4} \qquad ( 14 )$$

$$C = [ \begin{matrix}{\underbrace{\begin{matrix}ϛ & ϛ & … & & … & & 1 \\ 2 ϛ & 2 ϛ & & 2 ϛ & & {2}^{2} & 2 \\ ⋮ & & ⋱ & ⋮ & ⋰ & & ⋮ \\ \text{?} & \text{?} & … & & … & & \text{?}\end{matrix}}}_{( 3 ϛ - 1 ) / 2} \\ \end{matrix} ] / ( {\text{?}}^{3} \times \frac{ϛ - 1}{\text{?}} ) \qquad ( 15 )$$

$$\text{?} \text{indicates text missing or illegible when filed}$$

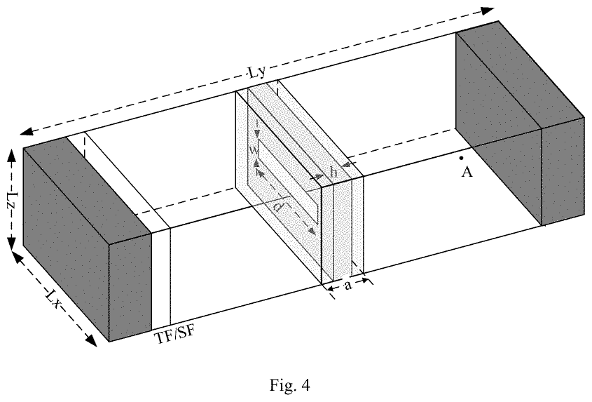

In order to verify the accuracy and efficiency of the proposed method herein, the frequency selective surface is taken as an example. The traditional FDTD algorithm and the proposed method are respectively used to calculate the time-domain waveform of the reflection field, the time-domain waveform of transmission field and transmission coefficient and reflection coefficient of the frequency selective surface. Referring to FIG. 4, the dimensions of the frequency selective surface are illustrated, that is Lₓ=0.15 mm, L_{z}=0.12 m, L_{y}=0.3 mm, h=0.01 mm, d=0.1 mm, w=0.2 mm and a=0.02 mm. The y-direction uses an absorbing boundary model of 11 convolutional perfect matched layers (CPML) to calculate an infinite computational space, and the x-direction and z-direction use periodic boundary conditions. The cosine-modulated plane wave is introduced through the total field/scattering field boundary, and the excitation source is specifically expressed as follows:

$${E}_{z} ( t ) = cos ( 2 π {f}_{c} ( t - {t}_{0} ) ) exp ( - {( \frac{t - {t}_{0}}{τ} )}^{2} ) \qquad ( 16 )$$

where f_{c}=1.25 GHz, tau=1.28 ns, and t₀=4×tau.

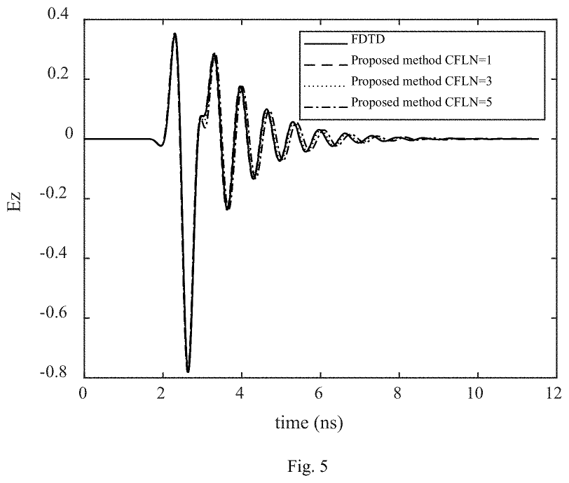

CFLN=Δt/Δt_{CFL} is defined for clarity, where Δt_{CFL} is a time step of the traditional FDTD algorithm under CFL conditions. As shown in FIGS. 5-7, the result obtained by the proposed method is basically consistent with the result obtained by the traditional FDTD algorithm. When CFLN=1, the result obtained by the proposed method herein and the result obtained by the traditional algorithm are basically the same. As the CFLN increases, the numerical error increases. Therefore, the ADI-FDTD algorithm proposed herein needs to balance the efficiency and accuracy.

In order to clearly illustrate the advantages of the ADI-FDTD algorithm proposed herein in saving computing resources and shortening computing time, Table 1 demonstrates the comparison results of the memory usage and the computing time required by the ADI-FDTD algorithm and the traditional FDTD algorithm.

TABLE 1
Comparison results of ADI-FDTD algorithm and traditional FDTD
algorithm in terms of memory usage and the computing time

| | | Proposed | Proposed | Proposed |
|---|---|---|---|---|
| | FDTD | method | method | method |
| | algorithm | CFLN = 1 | CFLN = 3 | CFLN = 5 |
| The number | 2.5e7 | 1.7e6 | 1.7e6 | 1.7e6 |
| of grids | | | | |
| The number | 1e4 | 1e4/1 | 1e4/3 | 1e4/5 |
| of iterative | | | | |
| steps | | | | |
| Memory | 7314.2 | 4441.2 | 4441.2 | 4441.2 |
| (MB) | | | | |
| Computing | 2.66e4 | 2.65e3 | 8.82e2 | 5.29e2 |
| time (s) | | | | |

As demonstrated from Table 1, compared with the traditional FDTD algorithm, when CFLN=5, the ADI-FDTD algorithm proposed herein can save 39.28% of memory and 98.01% of computing time.

This application is described with reference to the flowchart illustrations and/or block diagrams of the methods, apparatus (systems) and computer program products according to embodiments. It should be understood that each process and/or block in the flowchart illustrations and/or block diagrams, and combinations of processes and/or blocks in the flowchart illustrations and/or block diagrams, can be implemented by computer program instructions. These computer program instructions may be provided to a general-purpose computer, a special-purpose computer, an embedded processor or other programmable data processing device to produce a machine, such that the instructions executed by the processor of the computer or other programmable data processing device can be applied to produce a device that is capable of implementing the functions specified in a workflow or multiple workflows in a flowchart and/or a block or multiple blocks in a block diagram.

In this disclosure, relational terms such as “first” and “second” are merely used for description, and cannot be understood as indicating or implying their relative importance or the number of indicated technical features. Thus, the features defined with “first” and “second” may explicitly or implicitly include at least one of the features. In addition, unless otherwise expressly and specifically defined, the term “a plurality of” means two or more than two.

Obviously, it should be understood that any modifications or variations made by those skilled in the art without departing from the spirit of the application shall fall within the scope of the present application defined by the appended claims.

What is claimed is:

1. An electromagnetic field simulation method based on subgridding technique and one-step alternating-direction-implicit-finite-difference time-domain (ADI-FDTD) algorithm, comprising:
establishing an electromagnetic field simulation model by setting an absorption boundary condition, a periodic boundary condition, a total field boundary condition and a scattering field boundary condition based on the one-step ADI-FDTD algorithm, the subgridding technique and FDTD algorithm; wherein the electromagnetic field simulation model is configured to select a detection point and a detection surface, obtain a time-domain waveform diagram of a reflection field of a simulation area, a time-domain waveform diagram of a transmission field of the simulation area and frequency-domain information of the simulation area, and simulate an electromagnetic field.

2. The electromagnetic field simulation method of claim 1, wherein the step of “establishing an electromagnetic field simulation model” comprises:
based on the one-step ADI-FDTD algorithm, acquiring a first coefficient matrix corresponding to a boundary form of a perfect electric conductor and a second coefficient matrix corresponding to the periodic boundary condition; and
based on a tiny structure and a high dielectric constant of the simulation area, respectively generating the absorption boundary condition and the periodic boundary condition according to the first coefficient matrix and the second coefficient matrix.

3. The electromagnetic field simulation method of claim 2, wherein the step of “establishing an electromagnetic field simulation model” comprises:
obtaining a plane wave source by setting the total field boundary condition and the scattering field boundary condition; and
selecting the detection point and the detection surface according to the plane wave source.

4. The electromagnetic field simulation method of claim 3, wherein in the step of “establishing an electromagnetic field simulation model”, the electromagnetic field is simulated by:
based on the simulation area, setting a subgrid;
initializing an electric field component and a magnetic field component of a coarse grid, and initializing an electric field component and a magnetic field component of a dense grid;
calculating the electric field component of the coarse grid by FDTD algorithm;
after calculating an electric field component on an interface, transferring the electric field component on the interface to the dense grid by means of linear interpolation method; and using the one-step ADI-FDTD algorithm to calculate the electric field component of the dense grid and the magnetic field component of the dense grid; and
weighting the magnetic field component of the dense grid to obtain a magnetic field component on the interface; and using the FDTD algorithm to calculate the magnetic field component of the coarse grid.

5. The electromagnetic field simulation method of claim 4, wherein the step of “establishing an electromagnetic field simulation model” comprises: based on Maxwell equation, generating a two-step alternating-direction-implicit-finite-difference time-domain (ADI-FDTD) scheme based on an alternating-direction-implicit scheme; and
based on the two-step ADI-FDTD scheme, generating the one-step ADI-FDTD algorithm by algebraic operation.

6. The electromagnetic field simulation method of claim 5, wherein in the step of “generating a two-step alternating-direction-implicit-finite-difference time-domain (ADI-FDTD) scheme”, the two-step ADI-FDTD scheme comprises a first time step and a second time step;
the first time step is expressed as:
$$\begin{matrix}{E}^{n + 1 / 2} = {E}^{n} + \frac{Δ t}{2 ε} ( {AH}^{n + 1 / 2} - {BH}^{n} ) \\ {H}^{n + 1 / 2} = {H}^{n} + \frac{Δ t}{2 μ} ( {BE}^{n + 1 / 2} - {AE}^{n} )\end{matrix} ; and$$
the second time step is expressed as:
$$\begin{matrix}{E}^{n + 1} = {E}^{n + 1 / 2} + \frac{Δ t}{2 ε} ( {AH}^{n + 1 / 2} - {BH}^{n + 1} ) \\ {H}^{n + 1} = {H}^{n + 1 / 2} + \frac{Δ t}{2 μ} ( {BE}^{n + 1 / 2} - {AE}^{n + 1} )\end{matrix} ;$$
wherein E represents an electric field; H represents a magnetic field; ε is a dielectric constant; μ is a magnetic conductivity; a matrix A is expressed as:
$$A = [ \begin{matrix}0 & 0 & \partial / \partial y \\ \partial / \partial z & 0 & 0 \\ 0 & \partial / \partial x & 0\end{matrix} ] ;$$
and a matrix B is expressed as:
$$B = [ \begin{matrix}0 & \partial / \partial z & 0 \\ 0 & 0 & \partial / \partial x \\ \partial / \partial y & 0 & 0\end{matrix} ] .$$

7. The electromagnetic field simulation method of claim 6, wherein in the step of “generating the one-step ADI-FDTD algorithm”, the one-step ADI-FDTD algorithm is expressed as:
$$\begin{matrix}( I - \frac{Δ {t}^{2}}{4 με} AB ) {E}^{n + 1 / 2} = ( I - \frac{Δ {t}^{2}}{4 με} AB ) {E}^{n - 1 / 2} + \frac{Δ t}{ε} ( {AH}^{n} - {BH}^{n} ) \\ ( I - \frac{Δ {t}^{2}}{4 με} AB ) {H}^{n + 1} = ( I - \frac{Δ {t}^{2}}{4 με} AB ) {H}^{n} + \frac{Δ t}{μ} ( {BE}^{n + 1 / 2} - {AE}^{n + 1 / 2} )\end{matrix} .$$

8. The electromagnetic field simulation method of claim 7, wherein in the step of “respectively generating the absorption boundary condition and the periodic boundary condition according to the first coefficient matrix and the second coefficient matrix”, the first coefficient matrix is expressed as:
$$Λ = [ \begin{matrix}1 & 0 & 0 & 0 & 0 & 0 & 0 \\ b & a & b & 0 & 0 & 0 & 0 \\ 0 & ⊏ & ⊏ & ▯ & & & 0 \\ 0 & 0 & ▯ & ▯ & ⊏ & & \\ 0 & 0 & 0 & ▯ & ▯ & ⊏ & \\ 0 & 0 & 0 & 0 & b & a & b \\ 0 & 0 & 0 & 0 & 0 & 0 & 1\end{matrix} ] ;$$
and
the second coefficient matrix is expressed as:
$$Λ = [ \begin{matrix}a & b & 0 & 0 & 0 & 0 & b \\ b & a & b & 0 & 0 & 0 & 0 \\ 0 & ⊏ & ⊏ & ▯ & & & 0 \\ 0 & 0 & ▯ & ⊏ & ▯ & & \\ 0 & 0 & 0 & ▯ & ▯ & ▯ & \\ 0 & 0 & 0 & 0 & b & a & b \\ b & 0 & 0 & 0 & 0 & b & a\end{matrix} ] ;$$
wherein
$$a = 1 + \frac{Δ {t}^{2}}{2 εμΔ {y}^{2}} ; and b = - \frac{Δ {t}^{2}}{4 εμΔ {y}^{2}} .$$

9. The electromagnetic field simulation method of claim 8, wherein the frequency-domain information of the simulation area is obtained by acquiring a time-domain result of the detection surface to generate the frequency-domain information through Fourier transform.

10. The electromagnetic field simulation method of claim 9, wherein when the electromagnetic field is simulated, the electromagnetic field simulation method is stored in a storage medium in a form of a computer program, and applied to a device with a simulation function to simulate the electromagnetic field.
An electromagnetic field simulation method based on subgridding technique and one-step alternating-direction-implicit-finite-difference time-domain (ADI-FDTD) algorithm is provided herein. The method includes establishing an electromagnetic field simulation model by setting an absorption boundary condition, a periodic boundary condition, a total field boundary condition and a scattering field boundary condition based on the one-step ADI-FDTD algorithm, subgridding technique and FDTD algorithm. The electromagnetic field simulation model is configured to select a detection point and a detection surface, obtain a time-domain waveform diagram of a reflection field of a simulation area, a time-domain waveform diagram of a transmission field of the simulation area and frequency-domain information of the simulation area, and simulate an electromagnetic field, by the electromagnetic field simulation model.
